(19) United States
(12) Patent Application Publication
(10) Pub. No.: US 2006/0095296 A1
(43) Pub. Date: May 4, 2006

(54) System and method for improved data retrieval in a clinical reporting environment

(76) Inventor: Lawrence Erdman, Keller, TX (US)

Correspondence Address: MCANDREWS HELD & MALLOY, LTD, 500 WEST MADISON STREET, SUITE 3400, CHICAGO, IL, 60661, US

(21) Appl. No.: 10/979,520

(22) Filed: Nov. 2, 2004

(51) Int. Cl. G06Q 10/00; G06Q 50/00

(52) U.S. Cl. 705/2

(57) ABSTRACT

Certain embodiments of the present invention provide a system and method for interfacing with clinical data. The system and method provide for data acquisition independent from data operations. An input unit may acquire a command from a user. The command is communicated to a data engine unit. The data engine unit reads the command and acquires data from a database unit. The data engine unit communicates the data to an operation control unit. The operation control unit reads the command and selects an operation from an operation library unit. The operation is selected according to the command. The operation is executed and a result is returned. The result is communicated to the user.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to a system and method for interfacing with clinical data. In particular, the present invention relates to a system and method for improved data retrieval and processing of electronic medical records.

Medical records are typically confidential records that are kept for patients by a healthcare professional or organization. Medical records may contain personal details about the patient, such as name, address, date of birth, a summary of the patient's medical history, and documentation of each event, including symptoms, diagnosis, treatment and outcome. Medical records may also contain various data acquired during numerous visits to health care professionals. For example, medical records may contain laboratory values, vital signs, blood chemistry, urine panels, or any other types of data which may have been gathered throughout a patient's history. The primary focus of medical records is to provide as much information as possible about a patient to a healthcare provider to ensure appropriate healthcare.

Traditionally, medial records have been kept with pen and paper. As medical technology has become more sophisticated, however, the use of electronic medical records is becoming an important aide in the practice of healthcare providers. Using electronic medical records in place of traditional medical records offers many benefits to the healthcare provider. For example, electronic medical records offer superior organization, transferability, and presentation of data over traditional medical records. Storing electronic medical records is cheap and compact as compared to storing traditional medical records. Electronic medical records made by multiple healthcare providers in different locations and units can be linked and shared to create a single record for the individual. These benefits, among others, can increase the amount of information presented to a healthcare provider and thus increase the level of health care provided to a patient.

Many types of information may be presented to a healthcare provider using electronic medical records. For example, typical information available from a pen and paper medial record may be presented to a viewer of electronic medical records. Because, however, of the electronic nature of the data in an electronic medical record, various operations may be performed on the data and presented to a health care provider. Generally, in order to perform operations on data stored in an electronic medical record, the data is retrieved and processed. A typical technique is shown in FIG. 1.

FIG. 1 illustrates a typical system 100 for data retrieval and processing of electronic medical records. Generally, a user issues a command. The command may be a request for data, or a request for data coupled with an operation to be performed on the data. The command is generally acquired by an input unit 110. The input unit 110 then typically processes the command and generally compares the command with a library of routines available in the routine library 120. The routines available in the routine library 120 are generally software programs which involve acquiring data and some routines additionally involve operating on the data. If the command can be matched with one of the routines in the routine library 120, the routine may be executed. The selected routine may then acquire data from the electronic medical records database 130 and perform the operation.

For example, a user may issue a command to retrieve the last value of a patient's blood pressure. In the example of FIG. 1, the command may be acquired and processed by the input unit 110. The input unit 110 may compare the command to retrieve the last value of a patient's blood pressure with the routines available in the routine library 120. If a routine which can both acquire blood pressure data and compute the last value of the blood pressure data can be found, then the routine may be executed. If a routine which does not perform both functions does not exist, no routine will be executed and the user may not receive any information.

As the above example demonstrates, current systems and methods of interfacing with clinical data are limited by the dependence of the data acquired on the operation performed. In the above example, routines are limited by the field of “blood pressure” as well as a “last” operation. These limitations decrease the functionality of an interface, increase the complexity and number of routines available, as well as complicate the development process. Thus, it is highly desirable to have an interface with clinical data where the data acquired is independent of the operation requested.

Additionally, the dependence of the data acquired on the operation performed limits the types of data which may be operated upon. For example, a cardiologist may not use the same data fields or desire the same operations as would a dermatologist. Accordingly, a vender may not be able to anticipate all the data fields or desired operations from the wide range of users. Thus a need exists to provide a data retrieval and processing system which permits the customization of data.

Therefore, a need exists for a system and method which the data acquired is independent of the operation requested. Such a system and method may increase the functionality of interfaces, decease the complexity of available routines, as well as simplify the development process. Such a system and method may also provide a user the ability to customize data fields, and thus output.

### SUMMARY OF THE INVENTION

Certain embodiments of the present invention provide a system and method for interfacing with clinical data where the data acquired is independent of the operation requested. In an embodiment, the system for interfacing with clinical data includes an input unit for acquiring and processing at least one command, the command being from a user and including at least an acquisition statement for acquiring data. The system also includes a data engine unit for processing the command and acquiring data requested, the data being acquired from a database unit. The system also includes an operation control unit for processing the command and controlling the selection of an operation according to the command, the data being processed by the operation and returning a result according to the command. The system also includes an output unit for communicating the result to a user. Moreover, if a command includes only an acquisition statement, the operation control unit selects a default operation from the operation library. The default operation may be a null operation. If, however, the command includes an operation statement, the operation statement is used to control the selection of an operation from the operation library unit.

In an embodiment, the method for interfacing with clinical data includes acquiring a command, the command being from a user and including at least an acquisition statement. Next, the method includes acquiring data according to an acquisition statement. Then, selecting an operation according to the command. Next, communicating data to the operation according to the command. Next, executing the operation according to the command and returning a result. Finally, the method includes communicating the result to a user.

The system and method of the invention greatly increases the functionality of current electronic medical record applications, including retrieving and displaying clinical data.

### DESCRIPTION OF THE DRAWINGS

FIG. 1 illustrates a prior art system 100 for interfacing with clinical data.

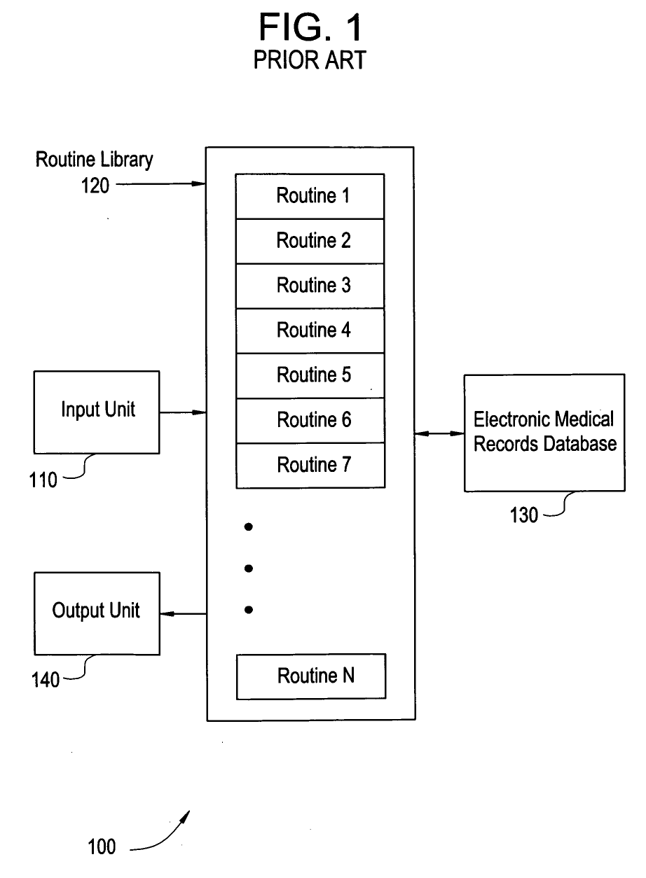

FIG. 2 illustrates a system 200 for interfacing with clinical data in accordance with an embodiment of the present invention.

FIG. 3 illustrates a method 300 for interfacing with clinical data in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

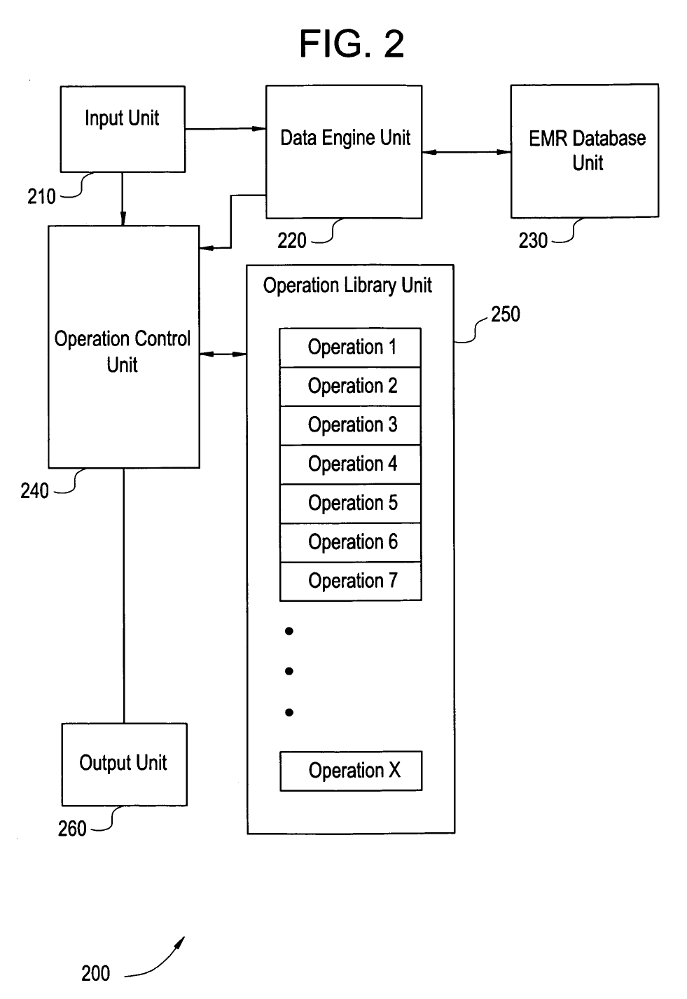

FIG. 2 illustrates system 200 for interfacing with clinical data in accordance with an embodiment of the present invention. The system 200 includes a input unit 210. The input unit 210 may acquire and process user commands. A data engine unit 220 processes user commands and acquires data from an electronic medical records database unit 230, hereinafter EMR database unit 230. An operation control unit 240 processes user commands and selects operations from an operation library unit 250. Operations are selected according to the commands issued by a user. The operation control unit 240 communicates data acquired from the EMR database unit to the operation selected from the operation library unit 250. The selected operation is then executed. The results of the operation are communicated to a user at the output unit 260.

The input unit 210 is in electrical communication with the data engine unit 220. The input unit 210 may also be in electrical communication with the operation control unit 240. The data engine unit 220 is in electrical communication with the EMR database unit 230 as well as the operation control unit 240. The operation control unit 240 is in electrical communication with the operation routine library 250 and the display unit 260. The components of the system 200 may be separate units, may be integrated in various forms, and may be implemented in hardware and/or in software.

The input unit 210 may acquire and process commands from a user. In an embodiment, the input unit 210 may be a computer with one or more devices to acquire commands from a user. For example, the computing device may be a typical personal computer, notebook computer, personal digital assistant, or other computing device. Typical devices used to acquire commands from a user may be a computer mouse, a computer keyboard, and/or a microphone. The mouse and keyboard may be used to acquire commands from a user. The microphone may be used with a voice recognition software program to acquire commands from a user.

The command acquired from a user may be a request to retrieve and process data. Data may be a single representation or a plurality of representations. For example, a patient's previous cholesterol measurement may be a single piece of data. Additionally, all available measurements of an individual's cholesterol may be data. Data may have ancillary information associated with entries, such as the date of the examination, medications, or other relevant information which may be stored in the EMR database unit 230.

The command issued by a user may include one or more parts. In an embodiment, the command may include an acquisition statement and an operation statement. The acquisition statement, may be any communication to the input unit 210 to acquire data stored in the EMR database unit 230. The acquisition statement may define which data a user desires. For example, a user may issue an acquisition statement “cholesterol.” In an embodiment, all available “cholesterol data” for that patient would be acquired from the EMR database unit 230. Other examples of acquisition statements are blood pressure, vital signs, medications, or any other classification of data.

The operation statement may define an operation for performance on the data referred to in the acquisition statement. The operation statement, may be any communication to the input unit 210 to operate on data acquired from the EMR database unit 230. An operation may be any mathematical, statistical, or medical calculation which can be performed on data. An operation may also utilize data to create various presentations of data, such as graphs or charts. For example, a user may issue an operation statement “average.” In an embodiment, the operation may utilize data acquired from database 230, and compute the average value of the data. Hence, for example, a command “average cholesterol” has an acquisition statement of cholesterol and an operation statement of average. In an embodiment, the system 200 would acquire all available cholesterol data for a patient and compute the average of the available cholesterol data.

Alternatively, the command issued by a user may include only an acquisition statement. In an embodiment, a command of only an acquisition statement may cause a default operation to be performed on the data. The default operation may be any available operation, including a null operation which returns the data unmodified. For example, a command of “cholesterol,” having only an acquisition statement, may cause the system 200 to acquire all available values of a patient's cholesterol. The default operation may be set by the user. For example, if a user wants the option of viewing all available data for an acquisition statement category, the user may set the default operation to a null operation. In such a case, a command of “cholesterol” may cause a null operation to be performed on the “cholesterol” data, returning unmodified available cholesterol data.

Alternatively, a user may want a command of only an acquisition statement to return the most recent value of the acquisition statement category. In the cholesterol example above, a command of “cholesterol” may cause an operation which sorts the data by entry date and return the most recent data. Other examples of a default operation may be any available operation. The default operation may be selected by the user.

Once the input unit 210 acquires a command from a user, the command is electrically communicated to the data engine unit 220 and the operation control unit 240. Alternatively, the command is electrically communicated to the data engine unit 220 and the data engine 220 electrically communicates the command to the operation control unit 240. The data engine unit 220 processes the acquisition statement of the command and acquires the requested data set from the EMR database unit 230. The data engine unit 220 then electrically communicates the retrieved data set to the operation control unit 240.

The operation control unit 240 processes the command and locates the presence of an operation statement. If the command does not have an operation statement, the operation control unit 240 selects the default operation discussed above. If the command has an operation statement, the operation control unit 240 selects an appropriate operation from the operation library unit 250.

Because, in an embodiment, the operation statement is independent of the acquisition statement, the operations comprising the operation library unit 250 may be generic. Generic operations may utilize any set of data to compute a result. For example, the operation “average,” may compute the average of a group of data, the operation “maximum” may compute the maximum of a group of data, or the operation “recent” may compute the most recent entry of a group of data. An operation may be any mathematical, statistical, or medical calculation which can be performed on data. An operation may also utilize data to create various presentations of data, such as graphs or charts.

Also, because the operation statement is independent of the acquisition statement, the data stored in the EMR database unit 230 is customizable. As mentioned above, the operations may process any set of data. A user wishing to store data unique to a specialty, such as cardiology or dermatology, in the EMR database unit 230 may create data sets which store data unique to their respective fields. A user may create data sets without losing the ability to perform operations on the created data sets.

Once the operation control unit 240 selects an appropriate operation from the operation library unit 250, the data is communicated to the selected operation. Once the data set is communicated to the selected operation, the operation is executed and a result is returned. The result may be electrically communicated to an output unit 260 for communicating the result to a user.

For example, a user may issue a command “average cholesterol.” The input unit 10 acquires the command and, in an embodiment, communicates the command to the data engine unit 220 and the operation control unit 240. The data engine unit 220 processes the acquisition statement of “cholesterol” to acquire all available cholesterol measurements from the EMR database unit 230. Once the data set is acquired, the data engine unit 220 communicates the cholesterol data to the operation control unit 240.

The operation control unit 240 processes the command and locates the presence of an operation statement. In the current example, the operation statement is “average.” The operation control unit 240 processes the operation statement of “average” to locate the “average” operation from the operation library unit 250. The cholesterol data is then communicated to the “average” operation. The “average” operation is executed and average cholesterol value is returned. In an embodiment, the average cholesterol value is displayed on output unit 260.

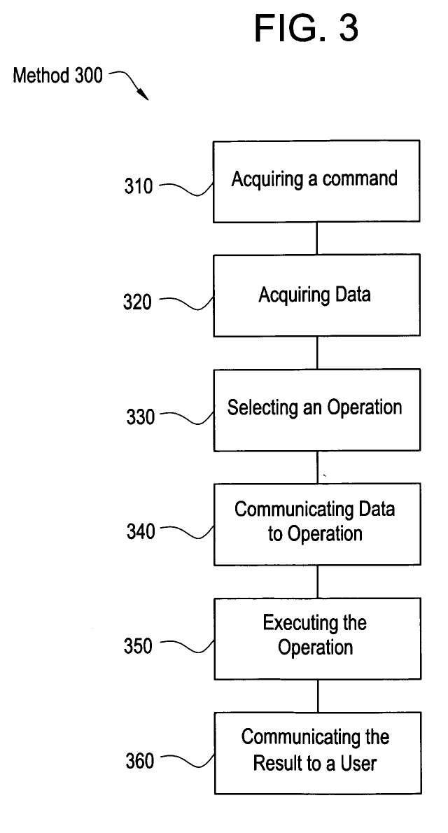

FIG. 3 illustrates a data retrieval and processing method 300 used in accordance with an embodiment of the present invention. At step 310, a command or signal is acquired. As mentioned above, the command may be communicated by a user through any input device, such as a computer keyboard, a computer mouse, or microphone. The command may be one or more parts, such as having an acquisition statement and an operation statement.

At step 320, data is retrieved from a database. In an embodiment, the portion of the command referred to as the “acquisition statement” above determines which data is retrieved from the database. At step 330, an operation is selected. In an embodiment, the portion of the command referred to as the “operation statement” above is used to select an operation.

At step 340, acquired data is communicated to the selected operation for processing. Next, at step 350 the operation is executed and a result is generated. Finally, at step 360, the result is communicated to a user.

For example, a user may issue a command “average cholesterol.” In an embodiment, the command is acquired at step 310. The command may be communicated in any form, including using a computer keyboard, a computer mouse, or a microphone and voice recognition software program. In the current example, the term “cholesterol” is the acquisition statement and the term “average” is the operation statement. At step 320, the term “cholesterol” may be used to retrieve all available cholesterol data from a database. Next, at step 330, the term “average” may be used to select the average operation from a library of operations. At step 340, the cholesterol data may be communicated to the average operation. At step 350, the average operation may be executed utilizing the cholesterol data and a result generated. At step 360, the value of the average cholesterol is communicated to a user.

The system and method described above may be carried out as part of a computer-readable storage medium including a set of instructions for a computer. The set of instructions includes a first acquisition routine acquiring at least one command from a user. The set of instructions also includes a second acquisition routine acquiring data according to the acquisition statement. A selection routine selects an operation according to the command. A first communicating routine communicates the data to the operation according to the command. An executing routine executes the operation according to the command and returns a result. A second communicating routine communicates the result to a user.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for interfacing with clinical data, said system comprising:
an input unit for acquiring and processing at least one command, said command being from a user and including at least an acquisition statement for acquiring data;
a data engine unit for processing said command and acquiring said data, said data being acquired from a database unit;
an operation control unit for processing said command and controlling the selection of an operation according to said command, said data being processed by said operation and returning a result according to said command; and
an output unit for communicating said result to a user.

2. The system of claim 1, wherein said command includes only an acquisition statement in which case said operation control unit selects a default operation from an operation library unit.

3. The system of claim 2, wherein said default operation is a null operation.

4. The system of claim 1, wherein said command includes an operation statement for controlling the selection of an operation from an operation library unit.

5. The system of claim 1, wherein said input unit is a computer, said computer acquiring commands from a user through one or more devices, said devices being a computer mouse, a computer keyboard, or a microphone.

6. The system of claim 5, wherein said commands are verbal commands, said commands being acquired by a microphone and processed with a voice recognition software program.

7. The system of claim 1, wherein said database unit is an electronic medical records database unit.

8. The system of claim 1, wherein said operation is selected from an operation library unit.

9. A method for interfacing with clinical data, said method comprising:
acquiring at least one command, said command being from a user and including at least an acquisition statement;
acquiring data according to said acquisition statement;
selecting an operation according to said command;
communicating said data to said operation according to said command;
executing said operation according to said command and returning a result; and
communicating said result to a user.

10. The method of claim 9, wherein said command includes only an acquisition statement in which case a default operation is selected from an operation library.

11. The method of claim 10, wherein said default operation is a null operation.

12. The method of claim 9, wherein said command includes an operation statement for controlling the selection of an operation from an operation library.

13. The method of claim 9, wherein said data is acquired by a computer, said computer acquiring commands from a user through one or more devices, said devices being a mouse, a keyboard, or a microphone.

14. The method of claim 13, wherein said commands are verbal commands, said commands being acquired by a microphone and processed with a voice recognition software program.

15. The method of claim 9, wherein said data is acquired from electronic medical records.

16. A computer-readable storage medium including a set of instructions for a computer, the set of instructions comprising:
a first acquisition routine acquiring at least one command, said command being from a user and including at least an acquisition statement;
a second acquisition routine acquiring data according to said acquisition statement;
a selection routine selecting an operation according to said command;
a first communicating routine communicating said data to said operation according to said command;
an executing routine executing said operation according to said command and returning a result; and
a second communicating routine communicating said result to a user.

17. The set of instructions of claim 16, wherein said command comprises only an acquisition statement in which case the selection routine selects default operation.

18. The set of instructions of claim 17, wherein said default operation is a null operation.

19. The set of instructions of claim 16, wherein said command includes an operation statement for controlling the selection of the operation by the selection routine.

20. The set of instructions of claim 16, wherein said first acquisition routine is a voice recognition software program.
